(19) United States
(12) Patent Application Publication
(10) Pub. No.: US 2025/0066112 A1
(43) Pub. Date: Feb. 27, 2025

(54) CUP WITH INTERIOR COATING OF INSTANT BEVERAGE

(71) Applicants: Raksha Balaji, Parkland, FL (US); Rakshi Balaji, Parkland, FL (US)

(72) Inventors: Raksha Balaji, Parkland, FL (US); Rakshi Balaji, Parkland, FL (US)

(21) Appl. No.: 18/455,112

(22) Filed: Aug. 24, 2023

(51) Int. Cl. B65D 85/816; A23F 5/36; A23L 2/39; A23L 23/10

(52) U.S. Cl. CPC B65D 85/816; A23F 5/36; A23L 2/39; A23L 23/10

(57) ABSTRACT

A prepared, single-use hot beverage cup includes a hot beverage cup substrate having a base and a sidewall around a container interior. The sidewall has an inner surface coated with a beverage concentrate which produces a beverage when hot water is poured into the container interior.

### BACKGROUND OF THE INVENTION

The present invention relates to instant beverages and, more particularly, to a cup with an interior coating of an instant beverage.

Generally, coffee must be made with a coffee machine or similar device. Coffee made with currently available coffee machines and instant coffee alike require a consumer to manually mix cream, sugar, etc. and instant coffee also requires manually mixing in water. Additional trash is generated, including, for example, brewing pods, stirrers, individual sugar and creamer packages, etc., harming the environment.

As can be seen, there is a need for a means of making coffee that does not require the consumer to use a coffee machine or generate additional waste.

### SUMMARY OF THE INVENTION

In one aspect of the present invention, a prepared, single-use hot beverage cup comprises a hot beverage cup substrate having a base and a sidewall around a container interior. The sidewall has an inner surface coated with a beverage concentrate and the beverage concentrate is operative to produce a beverage when hot water is provided in the container interior.

These and other features, aspects and advantages of the present invention will become better understood with reference to the following drawings, description, and claims.

### BRIEF DESCRIPTION OF THE DRAWINGS

FIG. 1 is a schematic view of a method of making and using a cup according to an embodiment of the present invention;

FIG. 2 is a flow chart thereof; and

FIG. 3 is a flat schematic view of a coated cup blank according to another embodiment of the present invention.

### DETAILED DESCRIPTION OF THE INVENTION

The following detailed description is of the best currently contemplated modes of carrying out exemplary embodiments of the invention. The description is not to be taken in a limiting sense but is made merely for the purpose of illustrating the general principles of the invention, since the scope of the invention is best defined by the appended claims.

Broadly, one embodiment of the present invention is a prepared, single-use coffee cup with an interior coating of beverage powder and/or paste.

As used herein, the term “single-use” means that the cup is manufactured of materials intended to be disposed of after a single use. The term “single-use” is not intended to be interpreted to mean that no other use may be found for the cup or that a user cannot re-use the cup, such as to add additional water to the cup, if the user so desires.

The term “hot water”, as used herein, refers to water that has a temperature greater than 98.6° F. and less than 212° F.

The term “cup blank” is well known to refer to a component of a paper or other disposable cup prior to assembly.

The inventive coated cup renders stirring unnecessary and is easy to use with less mess. The consumer is not required to manually mix milk powder with coffee and sugar.

The cup may have an interior coating of one or more ingredients selected from the group consisting of: coffee power paste, milk power paste, and sugar paste.

In some embodiments, the cup may be coated with other ingredients, e.g., dried juices or other food products, such as syrup or soup.

In some embodiments, the coating may extend from the bottom (i.e., base) to the top (i.e., rim) of the cup, and may increase in thickness, depth, or concentration from the bottom to the top of the cup.

In some embodiments, the ingredients may be extruded onto or printed onto a cup blank interior surface in a horizontal configuration. In other embodiments, the ingredients may be extruded onto or printed onto a cup blank interior surface in a vertical configuration.

The consumer may use the cup of the present subject matter to make coffee by merely pouring hot water into the coated cup.

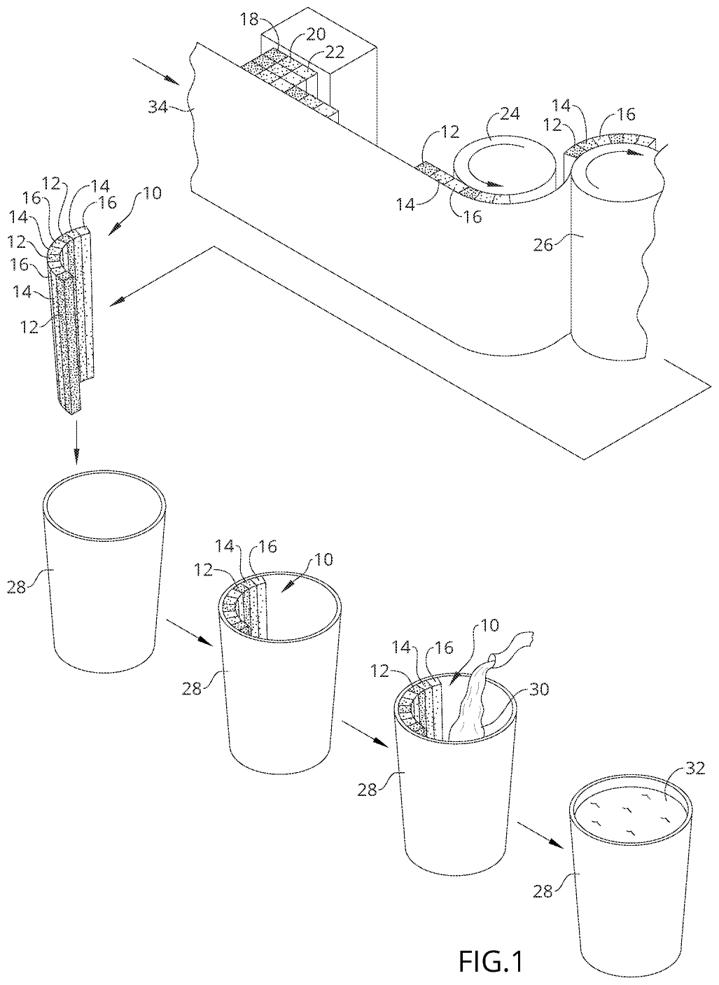

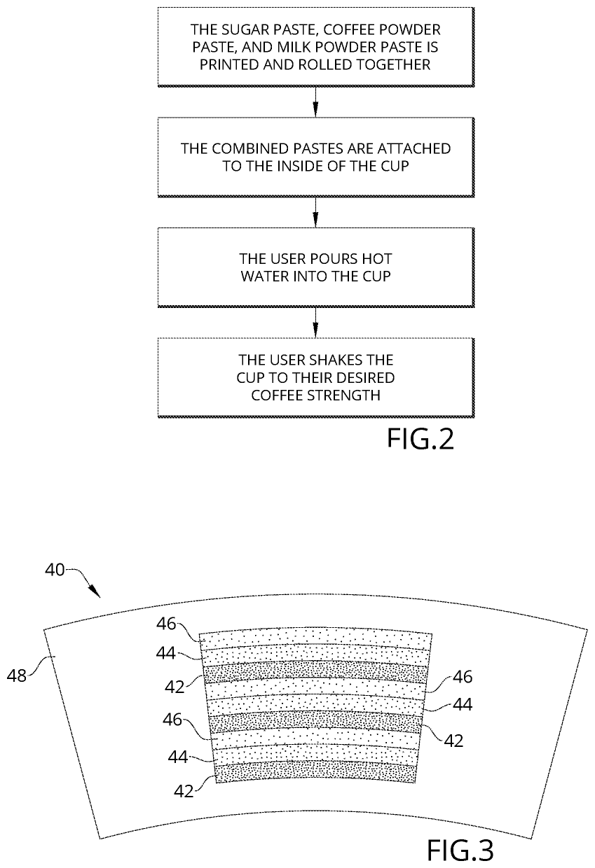

Referring to FIGS. 1 through 3, FIG. 1 illustrates a cup 28, having a base and a sidewall made of a hot beverage cup substrate such as paperboard, according to an embodiment of the present invention from production through use. A beverage concentrate printing apparatus comprising milk powder paste printer 18, a coffee powder paste printer 20, and a sugar paste printer 22 print milk powder paste 12, coffee powder paste 14, and sugar paste 16 onto a belt or paperboard substrate 34 in stripes adjacent to one another, which winds around a first roller 24 and a second roller 26 in the production process to produce a vertically-oriented combined paste 10. The pattern of individual pastes 12,14,16 is not particularly limited. If the combined paste 10 is not formed directly on the cup 28 paperboard, the combined paste 10 is installed on an interior surface of the sidewall of the cup 28. In order to make a cup 28 of coffee 32, the user may pour hot water 30 into the cup and allow the combined paste 10 to dissolve, with or without mixing, stirring, or shaking, or with shaking, as described in FIG. 2.

FIG. 3 illustrates an alternate embodiment in which a cup blank 48 is coated with combined pastes 40 (milk powder paste 42, coffee powder paste 44, and sugar paste 46) in a horizontal configuration.

It should be understood, of course, that the foregoing relates to exemplary embodiments of the invention and that modifications may be made without departing from the spirit and scope of the invention as set forth in the following claims.

What is claimed is:

1. A prepared, single-use hot beverage cup comprising:
a hot beverage cup substrate having a base and a sidewall around a container interior;
wherein the sidewall has an inner surface coated with a beverage concentrate, and
wherein the beverage concentrate is operative to produce a beverage when hot water is provided in the container interior.

2. The prepared, single-use hot beverage cup of claim 1, wherein the beverage concentrate comprises coffee power paste, milk power paste, and sugar paste positioned adjacent to one another.

3. The prepared, single-use hot beverage cup of claim 1, wherein the beverage concentrate is a dried juice.

4. The prepared, single-use hot beverage cup of claim 1, wherein the beverage concentrate is a syrup.

5. The prepared, single-use hot beverage cup of claim 1, wherein the beverage concentrate is a soup.

6. The prepared, single-use hot beverage cup of claim 1, wherein the beverage concentrate is extruded onto or printed onto a cup blank interior surface as stripes in a horizontal configuration.

7. The prepared, single-use hot beverage cup of claim 1, wherein the beverage concentrate is extruded onto or printed onto a cup blank interior surface as stripes in a vertical configuration.

8. The prepared, single-use hot beverage cup of claim 1, wherein the beverage concentrate extends from the base to a rim of the sidewall.

9. The prepared, single-use hot beverage cup of claim 8, wherein the beverage concentrate increases in thickness, depth, or concentration from the base to the rim of the sidewall.

10. A coffee cup manufacturing apparatus operative to produce the prepared, single-use coffee cup of claim 1, comprising:
a milk powder paste printer operative to print a milk powder paste onto a paperboard substrate;
a coffee powder paste printer operative to print a coffee powder paste onto the paperboard substrate and configured to print the coffee powder paste adjacent to the milk powder paste; and
a sugar paste printer operative to print a sugar paste onto the paperboard substrate and configured to print the sugar paste adjacent to either the milk powder paste or the coffee powder paste.
